(19) United States
(12) Patent Application Publication
(10) Pub. No.: US 2022/0169516 A1
(43) Pub. Date: Jun. 2, 2022

(54) GRAPHITE EXFOLIATION SYSTEM AND GRAPHITE EXFOLIATION METHOD USING THE SAME

(71) Applicant: P&B Materials Co., Ltd., Hwaseong-si (KR)

(72) Inventors: Deuk-Il Park, Hwaseong-si (KR); Ki-Yong Baek, Cheonan-si (KR)

(73) Assignee: P&B Materials Co., Ltd., Hwaseong-si (KR)

(21) Appl. No.: 17/336,211

(22) Filed: Jun. 1, 2021

(30) Foreign Application Priority Data
Nov. 27, 2020 (KR) 10-2020-0162120

(51) Int. Cl. C01B 32/225

(52) U.S. Cl. CPC C01B 32/225

(57) ABSTRACT

A graphite exfoliation system includes a first graphite exfoliation apparatus including a first inlet, a first pressurizing unit, a first high-pressure unit and a first extraction unit, a second graphite exfoliation apparatus including a second inlet, a second pressurizing unit, a second high-pressure unit and a second extraction unit, and a third graphite exfoliation apparatus including a third inlet, a third pressurizing unit, a third high-pressure unit and a third extraction unit, so as to allow the graphite powder to pass through an exfoliation process at least three times while gradually decreasing the inner cross-sectional areas of passages of the respective high-pressure units of the first, second and third graphite exfoliation apparatuses or maintaining the inner cross-sectional areas of the passages of the respective high-pressure units to be at least equal.

### BACKGROUND OF THE INVENTION

### Field of the Invention

The present invention relates to a graphite exfoliation system and a graphite exfoliation method using the same, and more particularly, to a graphite exfoliation system and a graphite exfoliation method using the same, the graphite exfoliation system including a first graphite exfoliation apparatus including a first inlet configured such that water, graphite powder and an additive are put thereinto, a first pressurizing unit connected to the first inlet and including a first pressurizing cylinder, a first high-pressure unit connected to the first pressurizing unit such that pressure applied by the first pressurizing cylinder is transmitted to the graphite powder in the first high-pressure unit, and a first extraction unit connected to the first high-pressure unit so as to extract primarily exfoliated graphite powder, a second graphite exfoliation apparatus including a second inlet configured such that the graphite powder extracted through the first extraction unit of the first graphite exfoliation apparatus is put thereinto, a second pressurizing unit connected to the second inlet and including a second pressurizing cylinder, a second high-pressure unit connected to the second pressurizing unit such that pressure applied by the second pressurizing cylinder is transmitted to the graphite powder in the second high-pressure unit, and a second extraction unit connected to the second high-pressure unit so as to extract secondarily exfoliated graphite powder, and a third graphite exfoliation apparatus including a third inlet configured such that the graphite powder extracted through the second extraction unit of the second graphite exfoliation apparatus is put thereinto, a third pressurizing unit connected to the third inlet and including a third pressurizing cylinder, a third high-pressure unit connected to the third pressurizing unit such that pressure applied by the third pressurizing cylinder is transmitted to the graphite powder in the third high-pressure unit, and a third extraction unit connected to the third high-pressure unit so as to extract thirdly exfoliated graphite powder.

### Description of the Related Art

In general, graphite is a crystalline form of the element carbon with its atoms arranged in a structure, in which hexagonal honeycomb lattices are stacked, and it occurs naturally in this form. Graphite has excellent thermal conductivity, and is thus widely used to radiate heat from electronic products. However, it is technically difficult for graphite existing in nature to exhibit characteristics for use in actual products.

In order to have characteristics for use in actual products, graphite must be exfoliated to have a thin thickness and a broad area. In more detail, in order to use graphite in actual products, graphite must be made into the form of graphite powder having particles with a small thickness and a large area, and this graphite powder must be used.

As representative methods for manufacturing graphite powder, there are a mechanical grinding method which grinds graphite into small particles, and a chemical manufacturing method which acquires graphite powder by performing oxidation treatment of graphite in sulfuric acid, expanding the graphite at a high temperature and exfoliating the expanded graphite using ultrasonic waves. However, both the mechanical grinding method and the chemical manufacturing method have technical limitations in acquisition of graphite powder having particles with a small thickness and a large area.

Graphite powder used for heat radiant materials, which is manufactured by the mechanical grinding method, depends on the size of graphite particles, and thus generally has particles having irregular shapes like fragmented stones. The graphite powder manufactured by the mechanical grinding method generally has a particle size equal to or less than 40 μm. The graphite powder manufactured by the mechanical grinding method has a small particle size, and may thus secure a high density, when the graphite powder is applied or molded, and control the particle size depending on a purpose, but has a great difficulty in controlling the thickness of the particles of the graphite powder, i.e., a structure in which hexagonal honeycomb lattices are stacked. Further, the proportion of the graphite powder accounted for by pores is low due to the high density, but the electrical conductivity or thermal conductivity of the graphite powder is reduced due to high contact resistance between the powder particles.

The chemical manufacturing method, which uses reduction-oxidation to manufacture graphite powder, has excellent productivity in exfoliation of graphite. However, a substance harmful to humans, such as sulfuric acid, is used and thus causes environmental problems, and it is difficult to acquire exfoliated graphite powder having a high purity due to poor manufacturing environments.

Graphite powder manufactured by performing oxidation-treatment of graphite in sulfuric acid using the chemical manufacturing method has a high volume and a very low density, and the graphite powder in this state is used in the form of a sheet so as to radiate heat from electronic products. Expanded graphite powder, which is used for heat radiant materials, generally has a particle size equal to or less than 300 μm. The expanded graphite powder microscopically has a similar shape as a bellows, and macroscopically has a similar shape as cotton and is light. However, as layers get spaced apart from each other like the shape of a bellows, a large number of pores is generated. Therefore, the expanded graphite powder has particles, which are thinner and greater in size than those of the graphite powder acquired by grinding natural graphite, and may thus have high electrical conductivity and high thermal conductivity, but thermal conductivity of the expanded graphite powder may be lowered due to a large number of pores between the particles thereof.

In order to solve degradation of characteristics of the expanded graphite powder due to many pores between the particles thereof, the expanded graphite powder may be compressed at a high pressure or graphite powder having a small particle size or conductive metal powder may be mixed with the expanded graphite powder, but these methods do not greatly improve the characteristics of the expanded graphite powder.

Particularly, it is technically very difficult to acquire graphite powder having particles with a small thickness and a large area through the conventional mechanical grinding method and chemical manufacturing method, and these methods have a limitation in reducing the amount of pores between the particles.

In order to use graphite in electronic products, the graphite needs to be exfoliated into graphite powder having particles with a small thickness and a large area and pores between the particles need to be minimized. For this purpose, technology which exfoliates graphite powder so as to have particles with a small thickness and a large area is required.

### RELATED ART DOCUMENT

### Patent Document

(Patent Document 0001) Korean Patent Unexamined Publication No. 10-2019-0037915 (Publication Date: Apr. 8, 2019)

### SUMMARY OF THE INVENTION

Therefore, the present invention has been made in view of the above problems, and it is an object of the present invention to provide a graphite exfoliation system and a graphite exfoliation method using the same, the graphite exfoliation system including a first graphite exfoliation apparatus including a first inlet configured such that water, graphite powder and an additive are put thereinto, a first pressurizing unit connected to the first inlet and including a first pressurizing cylinder, a first high-pressure unit connected to the first pressurizing unit such that pressure applied by the first pressurizing cylinder is transmitted to the graphite powder in the first high-pressure unit, and a first extraction unit connected to the first high-pressure unit so as to extract primarily exfoliated graphite powder, a second graphite exfoliation apparatus including a second inlet configured such that the graphite powder extracted through the first extraction unit of the first graphite exfoliation apparatus is put thereinto, a second pressurizing unit connected to the second inlet and including a second pressurizing cylinder, a second high-pressure unit connected to the second pressurizing unit such that pressure applied by the second pressurizing cylinder is transmitted to the graphite powder in the second high-pressure unit, and a second extraction unit connected to the second high-pressure unit so as to extract secondarily exfoliated graphite powder, and a third graphite exfoliation apparatus including a third inlet configured such that the graphite powder extracted through the second extraction unit of the second graphite exfoliation apparatus is put thereinto, a third pressurizing unit connected to the third inlet and including a third pressurizing cylinder, a third high-pressure unit connected to the third pressurizing unit such that pressure applied by the third pressurizing cylinder is transmitted to the graphite powder in the third high-pressure unit, and a third extraction unit connected to the third high-pressure unit so as to extract thirdly exfoliated graphite powder.

In accordance with an aspect of the present invention, the above and other objects can be accomplished by the provision of a graphite exfoliation system including a first graphite exfoliation apparatus including a first inlet configured such that water, graphite powder and an additive are put thereinto, a first pressurizing unit connected to the first inlet and including a first pressurizing cylinder, a first high-pressure unit connected to the first pressurizing unit such that pressure applied by the first pressurizing cylinder is transmitted to the graphite powder in the first high-pressure unit, and a first extraction unit connected to the first high-pressure unit so as to extract primarily exfoliated graphite powder, a second graphite exfoliation apparatus including a second inlet configured such that the graphite powder extracted through the first extraction unit of the first graphite exfoliation apparatus is put thereinto, a second pressurizing unit connected to the second inlet and including a second pressurizing cylinder, a second high-pressure unit connected to the second pressurizing unit such that pressure applied by the second pressurizing cylinder is transmitted to the graphite powder in the second high-pressure unit, and a second extraction unit connected to the second high-pressure unit so as to extract secondarily exfoliated graphite powder, and a third graphite exfoliation apparatus including a third inlet configured such that the graphite powder extracted through the second extraction unit of the second graphite exfoliation apparatus is put thereinto, a third pressurizing unit connected to the third inlet and including a third pressurizing cylinder, a third high-pressure unit connected to the third pressurizing unit such that pressure applied by the third pressurizing cylinder is transmitted to the graphite powder in the third high-pressure unit, and a third extraction unit connected to the third high-pressure unit so as to extract thirdly exfoliated graphite powder.

Each of inner cross-sectional areas of passages of the first high-pressure unit, the second high-pressure unit and the third high-pressure unit may be constant, the inner cross-sectional area of the passage of the first high-pressure unit may be equal to or greater than the inner cross-sectional area of the passage of the second high-pressure unit, and the inner cross-sectional area of the passage of the second high-pressure unit may be equal to or greater than the inner cross-sectional area of the passage of the third high-pressure unit.

The first high-pressure unit, the second high-pressure unit and the third high-pressure unit may be configured such that the inner cross-sectional areas of the passages thereof are within a range of 0.01 to 0.2 mm², and the graphite exfoliation system may further include a controller configured to control pressure applied to the graphite powder in each of the first high-pressure unit, the second high-pressure unit and the third high-pressure unit to be within a range of 100 to 900 bar.

At least one of the first high-pressure unit, the second high-pressure unit or the third high-pressure unit may include an adjuster configured to vary the inner cross-sectional area of the passage thereof.

In accordance with another aspect of the present invention, there is provided a graphite exfoliation method including preparing a graphite exfoliation system including a first graphite exfoliation apparatus including a first inlet configured such that water, graphite powder and an additive are put thereinto, a first pressurizing unit connected to the first inlet and including a first pressurizing cylinder, a first high-pressure unit connected to the first pressurizing unit such that pressure applied by the first pressurizing cylinder is transmitted to the graphite powder in the first high-pressure unit, and a first extraction unit connected to the first high-pressure unit so as to extract primarily exfoliated graphite powder, a second graphite exfoliation apparatus including a second inlet configured such that the graphite powder extracted through the first extraction unit of the first graphite exfoliation apparatus is put thereinto, a second pressurizing unit connected to the second inlet and including a second pressurizing cylinder, a second high-pressure unit connected to the second pressurizing unit such that pressure applied by the second pressurizing cylinder is transmitted to the graphite powder in the second high-pressure unit, and a second extraction unit connected to the second high-pressure unit so as to extract secondarily exfoliated graphite powder, and a third graphite exfoliation apparatus including a third inlet configured such that the graphite powder extracted through the second extraction unit of the second graphite exfoliation apparatus is put thereinto, a third pressurizing unit connected to the third inlet and including a third pressurizing cylinder, a third high-pressure unit connected to the third pressurizing unit such that pressure applied by the third pressurizing cylinder is transmitted to the graphite powder in the third high-pressure unit, and a third extraction unit connected to the third high-pressure unit so as to extract thirdly exfoliated graphite powder, putting water, the graphite powder and the additive into the first inlet, extracting the graphite powder passed through the first high-pressure unit through the first extraction unit by applying pressure to the graphite powder by the first pressurizing cylinder of the first pressurizing unit, putting the graphite powder extracted through the first extraction unit into the second inlet, extracting the graphite powder passed through the second high-pressure unit through the second extraction unit by applying pressure to the graphite powder by the second pressurizing cylinder of the second pressurizing unit, putting the graphite powder extracted through the second extraction unit into the third inlet, and extracting the graphite powder passed through the third high-pressure unit through the third extraction unit by applying pressure to the graphite powder by the third pressurizing cylinder of the third pressurizing unit.

Each of inner cross-sectional areas of passages of the first high-pressure unit, the second high-pressure unit and the third high-pressure unit may be constant, the inner cross-sectional area of the passage of the first high-pressure unit may be equal to or greater than the inner cross-sectional area of the passage of the second high-pressure unit, the inner cross-sectional area of the passage of the second high-pressure unit may be equal to or greater than the inner cross-sectional area of the passage of the third high-pressure unit, the first high-pressure unit, the second high-pressure unit and the third high-pressure unit may be configured such that the inner cross-sectional areas of the passages thereof are within a range of 0.01 to 0.2 mm², and the graphite exfoliation system may further include a controller configured to control pressure applied to the graphite powder in each of the first high-pressure unit, the second high-pressure unit and the third high-pressure unit to be within a range of 100 to 900 bar.

A weight of the additive put into the first inlet may be less than 5% of a weight of the graphite powder put together with the additive into the first inlet, the additive may be a carbon compound having a designated viscosity, and the third high-pressure unit may include an adjuster configured to vary the inner cross-sectional area of the passage thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a graphite exfoliation system according to the present invention;

FIG. 2 is a flowchart illustrating the sequence of a graphite exfoliation method according to the present invention;

FIGS. 3(a) and 3(b) are SEM images illustrating graphite exfoliated using a conventional grinding apparatus; and

FIGS. 4(a) to 4(c) are SEM images illustrating graphite exfoliated using the graphite exfoliation system according to the present invention.

### DETAILED DESCRIPTION OF THE INVENTION

Hereinafter, reference will be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments.

It will be understood that the drawings are merely exemplarily illustrated, but are not illustrated to scale. The relative sizes and ratios of elements given in the drawings may be exaggerated or reduced for clarity and convenience in the drawings, and the shapes, sizes, ratios, angles, the number of the elements given in the drawings are merely exemplary and thus, the present disclosure is not limited to the illustrated details. In the following description of the embodiments and the drawings, the same or similar structures, elements or parts are denoted by the same reference numerals.

Hereinafter, an exemplary embodiment of the present invention will be described in detail, and thus, various modifications of the drawings are possible. Therefore, the embodiment is not limited to a specific form in a region illustrated in the drawings, and may include, for example, modifications of the form due to manufacturing.

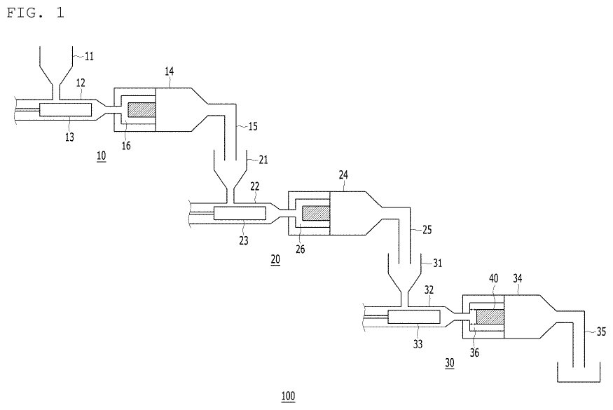

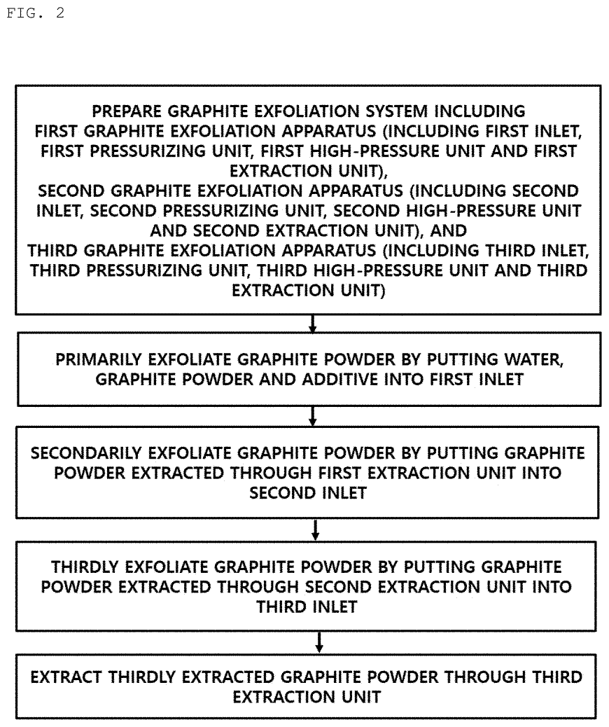

FIG. 1 is a view illustrating a graphite exfoliation system according to the present invention, and FIG. 2 is a flowchart illustrating the sequence of a graphite exfoliation method according to the present invention.

A graphite exfoliation system 100 according to the present invention includes a first graphite exfoliation apparatus 10, a second graphite exfoliation apparatus 20 and a third graphite exfoliation apparatus 30.

The first graphite exfoliation apparatus 10 includes a first inlet 11 into which that water, graphite powder and an additive are put, a first pressurizing unit 12 connected to the first inlet 11 and including a first pressurizing cylinder 13, a first high-pressure unit 14 connected to the first pressurizing unit 12 such that pressure applied by the first pressurizing cylinder 13 is transmitted to the graphite powder in the first high-pressure unit 14, and a first extraction unit 15 connected to the first high-pressure unit 14 so as to extract primarily exfoliated graphite powder.

The second graphite exfoliation apparatus 20 includes a second inlet 21 into which the graphite powder extracted through the first extraction unit 15 of the first graphite exfoliation apparatus 10 is put, a second pressurizing unit 22 connected to the second inlet 21 and including a second pressurizing cylinder 23, a second high-pressure unit 24 connected to the second pressurizing unit 22 such that pressure applied by the second pressurizing cylinder 23 is transmitted to the graphite powder in the second high-pressure unit 24, and a second extraction unit 25 connected to the second high-pressure unit 24 so as to extract secondarily exfoliated graphite powder.

The third graphite exfoliation apparatus 30 includes a third inlet 31 into which the graphite powder extracted through the second extraction unit 25 of the second graphite exfoliation apparatus 20 is put, a third pressurizing unit 32 connected to the third inlet 31 and including a third pressurizing cylinder 33, a third high-pressure unit 34 connected to the third pressurizing unit 32 such that pressure applied by the third pressurizing cylinder 33 is transmitted to the graphite powder in the third high-pressure unit 34, and a third extraction unit 35 connected to the third high-pressure unit 34 so as to extract thirdly exfoliated graphite powder.

The pressure applied by the first pressurizing unit 12 allows the graphite powder to pass through a first high-pressure unit passage 16 so as to primarily exfoliate the graphite powder, and the primarily exfoliated graphite powder is extracted through the first extraction unit 15. Through the first graphite exfoliation apparatus 10, the second graphite exfoliation apparatus 20 and the third graphite exfoliation apparatus 30, which are continuously connected, the primarily exfoliated graphite powder is secondarily exfoliated in the second graphite exfoliation apparatus 20, and the secondarily exfoliated graphite powder is thirdly exfoliated in the third graphite exfoliation apparatus 30 in the same process. In order to perform continuous processing, the graphite exfoliation system 100 must be designed such that the graphite powder extracted through the first extraction unit 15 is put into the second inlet 21 and the graphite powder extracted through the second extraction unit 25 is put into the third inlet 31.

Each of the inner cross-sectional areas of the passages 16, 26 and 36 of the first high-pressure unit 14, the second high-pressure unit 24 and the third high-pressure unit 34 may be constant, the inner cross-sectional area of the passage 16 of the first high-pressure unit 10 may be equal to or greater than the inner cross-sectional area of the passage 26 of the second high-pressure unit 20, and the inner cross-sectional area of the passage 26 of the second high-pressure unit 20 may be equal to or greater than the inner cross-sectional area of the passage 36 of the third high-pressure unit 30. Each of the passages 16, 26 and 36 may have a circular cross-section.

The inner cross-sectional areas of the passages 16, 26 and 36 of the first high-pressure unit 14, the second high-pressure unit 24 and the third high-pressure unit 34 are within the range of 0.01 to 0.2 mm², and the graphite exfoliation system 100 includes a controller which controls pressure applied to the graphite powder in each of the first high-pressure unit 14, the second high-pressure unit 24 and the third high-pressure unit 34 to be within the range of 100 to 900 bar.

At least one of the first high-pressure unit 14, the second high-pressure unit 24 or the third high-pressure unit 34 may include an adjuster which varies the inner cross-sectional area of the passage thereof. Preferably, the inner cross-sectional areas of the passages 16 and 26 of the first high-pressure unit 14 and the second high-pressure unit 24 may be fixed, and the inner cross-sectional area of the passage 36 of the third high-pressure unit 34 may be adjusted by the adjuster. The reason for this is that, when the graphite powder is additionally exfoliated after third exfoliation, it is difficult to indefinitely increase the number of graphite exfoliation apparatuses, and thus, by adjusting the inner cross-sectional area of the passage 36 of the third high-pressure unit 30 using the adjuster after third exfoliation, the inner cross-sectional area of the passage 36 of the third high-pressure unit 30 for nth exfoliation (n being a natural number equal to or greater than 4) is adjusted to be equal to or smaller than the inner cross-sectional area of the passage 36 of the third high-pressure unit 30 for (n−1)th exfoliation.

That is, in order to acquire high-quality exfoliated graphite, exfoliation needs to be performed at least three times and, as the number of exfoliations increases, the inner cross-sectional areas of the passages of the high-pressure units through which the graphite powder passes are set to be gradually decreased or to be at least equal to the inner cross-sectional area of the passage of the former high-pressure unit, thereby allowing the graphite powder to be continuously exfoliated.

A graphite exfoliation method according to the present invention includes preparing a graphite exfoliation system 100 including a first graphite exfoliation apparatus 10 including a first inlet 11 into which that water, graphite powder and an additive are put, a first pressurizing unit 12 connected to the first inlet 11 and including a first pressurizing cylinder 13, a first high-pressure unit 14 connected to the first pressurizing unit 12 such that pressure applied by the first pressurizing cylinder 13 is transmitted to the graphite powder in the first high-pressure unit 14, and a first extraction unit 15 connected to the first high-pressure unit 14 so as to extract primarily exfoliated graphite powder, a second graphite exfoliation apparatus 20 including a second inlet 21 into which the graphite powder extracted through the first extraction unit 15 of the first graphite exfoliation apparatus 10 is put, a second pressurizing unit 22 connected to the second inlet 21 and including a second pressurizing cylinder 23, a second high-pressure unit 24 connected to the second pressurizing unit 22 such that pressure applied by the second pressurizing cylinder 23 is transmitted to the graphite powder in the second high-pressure unit 24, and a second extraction unit 25 connected to the second high-pressure unit 24 so as to extract secondarily exfoliated graphite powder, and a third graphite exfoliation apparatus 30 including a third inlet 31 into which the graphite powder extracted through the second extraction unit 25 of the second graphite exfoliation apparatus 20 is put, a third pressurizing unit 32 connected to the third inlet 31 and including a third pressurizing cylinder 33, a third high-pressure unit 34 connected to the third pressurizing unit 32 such that pressure applied by the third pressurizing cylinder 33 is transmitted to the graphite powder in the third high-pressure unit 34, and a third extraction unit 35 connected to the third high-pressure unit 34 so as to extract thirdly exfoliated graphite powder.

Thereafter, the graphite exfoliation method according to the present invention further includes putting water, the graphite powder and the additive into the first inlet 11, and extracting the graphite powder passed through the first high-pressure unit 14 through the first extraction unit 15 by applying pressure to the graphite powder by the first pressurizing cylinder 13 of the first pressurizing unit 12.

The graphite exfoliation method according to the present invention further includes putting the graphite powder extracted through the first extraction unit 15 into the second inlet 21, extracting the graphite powder passed through the second high-pressure unit 24 through the second extraction unit 25 by applying pressure to the graphite powder by the second pressurizing cylinder 23 of the second pressurizing unit 22, putting the graphite powder extracted through the second extraction unit 25 into the third inlet 31, and extracting the graphite powder passed through the third high-pressure unit 34 through the third extraction unit 35 by applying pressure to the graphite powder by the third pressurizing cylinder 33 of the third pressurizing unit 32, thereby allowing the graphite powder to pass through the exfoliation process at least three times while gradually decreasing the inner cross-sectional areas of the passages 16, 26 and 36 of the high-pressure units 14, 24 and 34 or maintaining the inner cross-sectional areas of the passages 16, 26 and 36 to be to be at least equal.

Each of the inner cross-sectional areas of the passages 16, 26 and 36 of the first high-pressure unit 14, the second high-pressure unit 24 and the third high-pressure unit 34 may be constant, the inner cross-sectional area of the passage 16 of the first high-pressure unit 10 may be equal to or greater than the inner cross-sectional area of the passage 26 of the second high-pressure unit 20, the inner cross-sectional area of the passage 26 of the second high-pressure unit 20 may be equal to or greater than the inner cross-sectional area of the passage 36 of the third high-pressure unit 30, the inner cross-sectional areas of the passages 16, 26 and 36 of the first high-pressure unit 14, the second high-pressure unit 24 and the third high-pressure unit 34 may be within the range of 0.01 to 0.2 mm², and the graphite exfoliation system 100 may include a controller which controls pressure applied to the graphite powder in each of the first high-pressure unit 14, the second high-pressure unit 24 and the third high-pressure unit 34 to be within the range of 100 to 900 bar.

Each of the passages 16, 26 and 36 of the first high-pressure unit 14, the second high-pressure unit 24 and the third high-pressure unit 34 may be one of a fixed type and a variable type. The fixed type is a device, the passage of which has a constant cross-sectional area, and the variable type is a device, the passage of which has a cross-sectional area which may be adjusted using an adjuster, as shown in FIG. 1.

The weight of the additive put into the first inlet 11 may be less than 5% of the weight of the graphite powder put together with the additive into the first inlet 11, the additive may be a carbon compound having a designated viscosity, and the third high-pressure unit 34 may include an adjuster configured to vary the inner cross-sectional area of the passage 36 thereof. The reason why the adjuster is provided to vary the inner cross-sectional area of the passage 36 of the third high-pressure unit 34 is that, when fourth or more exfoliation is performed, no additional graphite exfoliation apparatus is provided and the third graphite exfoliation apparatus 30 performs the fourth or more exfoliation by varying the inner cross-sectional area of the passage 36 of the third high-pressure unit 34 of the third graphite exfoliation apparatus 30.

Each of the passages 16, 26 and 36 of the first high-pressure unit 14, the second high-pressure unit 24 and the third high-pressure unit 34 may be one of a fixed type and a variable type. The fixed type is a device, the passage of which has a constant cross-sectional area, and the variable type is a device, the passage of which has a cross-sectional area which may be adjusted using an adjuster, as shown in FIG. 1.

The graphite exfoliation apparatus and the graphite exfoliation method using the same according to the present invention may exhibit effects only when the graphite powder sequentially passes through the passages of at least three high-pressure units, and may be configured such that, when the graphite powder sequentially passes through the passages of the three high-pressure units, the graphite powder may be put into the passage of one high-pressure unit and the exfoliated graphite powder may be extracted therefrom and then be put into the passage of the next high-pressure unit, or may be configured such that the graphite powder may successively pass through the passages of the three high-pressure units by connecting the respective passages.

Graphite is an electrically conductive substance in which many layers of the element carbon with its atoms arranged in a structure, in which hexagonal honeycomb lattices are stacked, are combined by Van der Waals force, and exfoliated graphite according to the present invention has excellent electrical conductivity and may thus be used as a conductive ink, a battery conductor, a heat radiant film and a catalyst additive.

In conventional technology for chemically exfoliating natural graphite, a chemical substance, such as highly concentrated sulfuric acid, is used and a great quantity of water is used to reduce oxidized graphite and thus environmental contamination is caused, and even though the oxidized graphite is reduced, it is not possible to completely reduce the oxidized graphite and thus it is difficult to maintain the intrinsic electrical characteristics of natural graphite. On the contrary, in the graphite exfoliation system and the graphite exfoliation method using the same according to the present invention, natural graphite is mechanically exfoliated, and thus, high-quality exfoliated graphite having particles with a small thickness equal to or less than 5 nm and excellent conductivity may be acquired without environment contamination.

There are various kinds of mechanical apparatuses which grind minerals in a powder form, such as graphite, or grains using physical force depending on purposes. As representative grinders, there are a ball mill, a bead mill, a high shear mixer, a jet mill, an ultrasonicator, etc. These grinding apparatuses may effectively grind particles so as to have a small size mainly using collision energy. These grinding apparatuses may grind large particles into small particles having a size of several μm, but are difficult to exfoliate particles having a stack structure, such as graphite, so as to have a thin thickness equal to or less than several nm. In the conventional grinding apparatuses, even though strong collision between particles repeatedly occurs, the collision does not occur in a constant direction, and thus, the particles may be ground or crushed but it is difficult to acquire local and directional frictional energy necessary to separate stacked layers from each other. Therefore, when natural graphite is ground using these conventional grinding apparatuses, it is difficult to acquire exfoliated graphite having a small thickness.

A superhigh-pressure dispenser is applied as a mechanical apparatus which processes particles using collision energy and friction energy. In the superhigh-pressure dispenser used to disperse powder having small particles or a liquid substance which is not uniformly mixed, when a liquid substance having a low viscosity is injected into a very narrow passage having a diameter of 70-120 μm at a high speed, a very high pressure of about 1,000 bar is generated in a high-pressure unit, and the liquid substance passes through the narrow passage at a very high speed while causing strong collision and friction between particles of the liquid substance.

The high-pressure unit having the passage having a diameter of 70-120 μm is generally formed of a material having excellent wear resistance. In the passage having a diameter of equal to or less than about 0.12 mm and a cross-sectional area of about 0.01 mm², particles are ground and exfoliated while causing very strong collision and friction, and such a superhigh-pressure dispenser is being widely used in production of medicine and medical supplies, cosmetics, and groceries. Because the passage of the high-pressure unit of the conventional superhigh-pressure dispenser is very narrow, if natural graphite powder is processed, particles having a size of equal to or less than about 5 μm may be used, and when water and the natural graphite powder are mixed, viscosity must be low. When the size of natural graphite particles is great or the viscosity of the mixture of water and the natural graphite powder is high, the passage of the high-pressure unit may be clogged, and thus, the pressure may be rapidly increased to 1,300 bar or higher and the dispenser may be stopped or break down. When natural graphite powder is exfoliated using such a conventional superhigh-pressure dispenser, economic infeasibility is caused by use of high-priced natural graphite powder having a particle size of equal to or less than about 5 μm, and the particle size of the exfoliated graphite powder is limited to about 1 μm or less.

In order to overcome the limit in the particle size of natural graphite powder when natural graphite is exfoliated using the conventional superhigh-pressure dispenser, the present invention provides the natural graphite exfoliation system 100 which may exfoliate a large amount of graphite powder having a particle size of hundreds of μm. In order to exfoliate graphite powder having a particle size of hundreds of μm, the passage of the high-pressure unit may have a cross-sectional area greater than the cross-sectional area, i.e., 0.01 mm², of the conventional high-pressure unit so as not to be clogged, and may have a long length so as to effectively and repeatedly perform exfoliation. The graphite powder needs to pass through the high-pressure unit at least three times so as to repeatedly perform exfoliation, and the high-pressure unit maintains a pressure of 100-900 bar. A small amount of the additive may be added so as to facilitate exfoliation and dispersion of natural graphite powder, and preferably, the weight of the additive may be equal to or less than 5% of the weight of the graphite powder so as to prevent an excessively increase in viscosity.

The inner cross-sectional areas of the passages 16, 26 and 36 of the first high-pressure unit 14, the second high-pressure unit 24 and the third high-pressure unit 34 may be set to about 0.19 mm², 0.03 mm² and 0.015 mm², respectively. Concretely, the first high-pressure unit 14 configured to primarily exfoliate a fluent substance including natural graphite powder may be a fixed-type high pressure unit including a passage having an inner cross-sectional area of 0.19 mm² and having an operating pressure of 100 to 400 bar, the second high-pressure unit 24 may be a fixed-type high pressure unit including a passage having an inner cross-sectional area of 0.03 mm² and having an operating pressure of 400 to 650 bar, and the third high-pressure unit 34 may maintain an inner cross-sectional area of 0.015 mm² of a passage thereof and an operating pressure of 650 to 900 bar, so as to perform exfoliation at least three times.

When natural graphite powder is exfoliated using the graphite exfoliation system 100 including the high-pressure units 14, 24 and 34 having the passages 16, 26 and 36 having different cross-sectional areas, in order to obtain exfoliated graphite having a smaller thickness, exfoliation may be repeatedly performed in the high-pressure unit having a narrow passage of the final graphite exfoliation apparatus 30. In order to exfoliate natural graphite powder, exfoliated graphite powder having a particle size of about 5 μm and a particle thickness of 5 nm or less is obtained by processing a fluent substance in a liquid state, in which water, natural graphite powder having a particle size of about 300 μm, and a small amount of a dispersant are mixed in a designated ratio, using the graphite exfoliation system 100 including the graphite exfoliation apparatuses 10, 20 and 30. It was confirmed from a scanning electron microscope (SEM) that, when the graphite exfoliation system 100 including the three graphite exfoliation apparatuses 10, 20 and 30 was used, natural graphite powder having a large particle size was effectively exfoliated. In order to uniformly and stably obtain exfoliated graphite having a small particle thickness, the natural graphite powder may pass through a high-pressure unit at least three times.

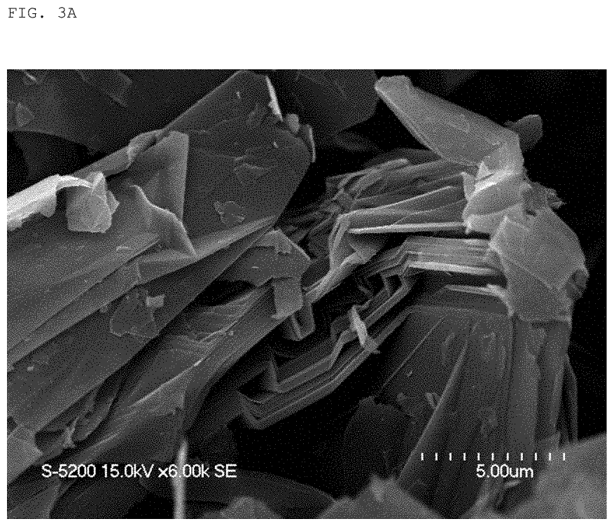

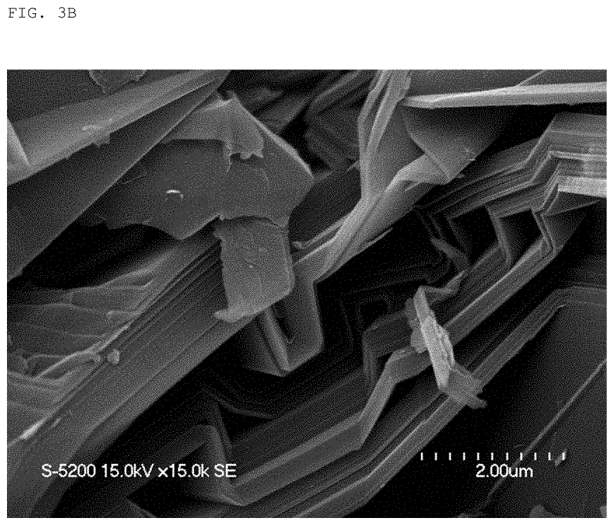

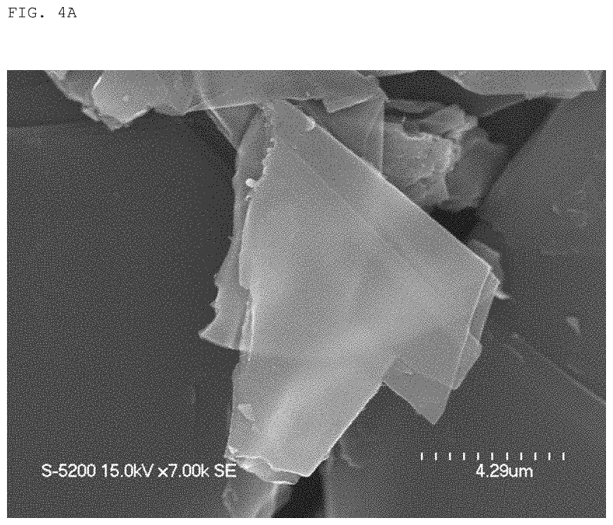

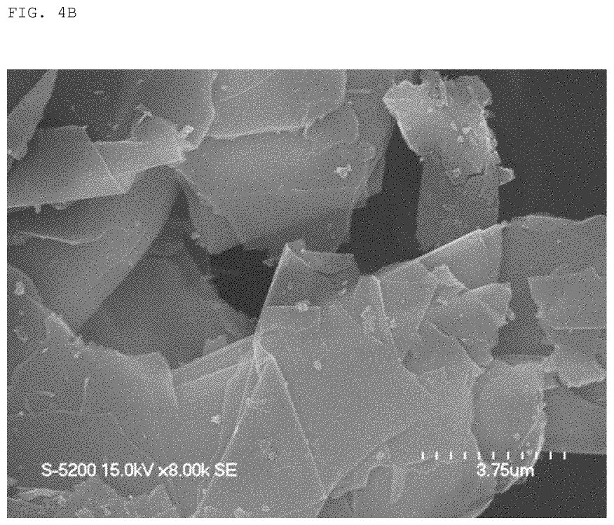

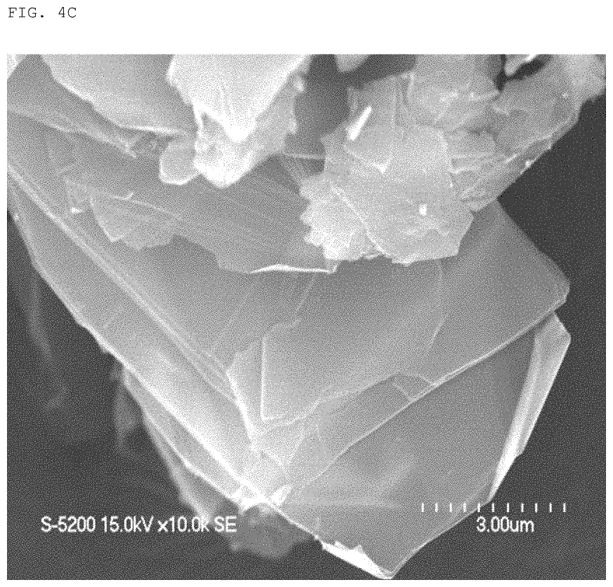

FIGS. 3(a) and 3(b) are SEM images illustrating graphite exfoliated using the conventional grinding apparatus, and FIGS. 4(a) to 4(c) are SEM images illustrating graphite exfoliated using the graphite exfoliation system 100 according to the present invention.

In order to obtain high-quality exfoliated graphite shown in FIGS. 4(a) to 4(c), the first high-pressure unit 14, the second high-pressure unit 24 and the third high-pressure unit 34 were designed such that the inner cross-sectional areas of the passages 16, 26 and 36 thereof are within the range of 0.01 to 0.19 mm², and the inner cross-sectional area of the passage 26 of the second high-pressure unit 20 is equal to or less than the inner cross-sectional area of the passage 16 of the first high-pressure unit 10 and the inner cross-sectional area of the passage 36 of the third high-pressure unit 30 is equal to or less than the inner cross-sectional area of the passage 26 of the second high-pressure unit 20 so that the cross-sectional areas of the passages 16, 26 and 36 of the first high-pressure unit 14, the second high-pressure unit 24 and the third high-pressure unit 34 are equal or are gradually decreased. Further, pressure applied to the graphite powder in each of the first high-pressure unit 14, the second high-pressure unit 24 and the third high-pressure unit 34 was controlled to be within the range of 100 to 900 bar, as described above. Further, the third high-pressure unit 34 is designed as a variable type having a passage, the cross-sectional area of which may be adjusted using the adjuster, and the reason for this is that, when the graphite powder additionally passes through another passage after passing through the third passage 36, it is difficult to indefinitely increase the number of graphite exfoliation apparatuses, and thus, the graphite powder may pass through the third passage 36, the cross-sectional area of which is decreased or at least fixed by the adjuster, again. In this case, after the graphite powder passes through the first high-pressure unit 14 and the second high-pressure unit 24 having the passages 16 and 26, the cross-sectional areas of which are fixed, and then passes through the third high-pressure unit 34 having the passage 36, the cross-sectional area of which is variable, the cross-sectional area of the passage 36 of the third high-pressure unit 34 is adjusted by the adjuster, and the graphite powder passes through the third high-pressure unit 34 again, thereby being capable of being exfoliated.

As results of various tests performed under the above-described conditions, it was found out that the following embodiment exhibited desirable exfoliation efficiency.

[Test Conditions]

| | | | Control of |
|---|---|---|---|
| | | | pressure in |
| | Cross-sectional area | Type | passage |
| First passage | About 0.19 mm² | Fixed | 100-400 bar |
| Second passage | About 0.03 mm² | Fixed | 400-650 bar |
| Third passage | About 0.015 mm² | Variable | 650-900 bar |

That is, it may be confirmed from FIGS. 3(a) and 3(b) and FIGS. 4(a) to 4(c) that the exfoliated graphite obtained by exfoliating graphite powder using the graphite exfoliation system designed to have the above test conditions according to the present invention, as shown in FIGS. 4(a) to 4(c), exhibits excellent quality, i.e., has a small thickness of 5 mm or less, compared to the exfoliated graphite obtained using the conventional grinding apparatus, as shown in FIGS. 3(a) and 3(b).

As is apparent from the above description, the present invention provides a graphite exfoliation system and a graphite exfoliation method using the same, the graphite exfoliation system including a first graphite exfoliation apparatus including a first inlet configured such that water, graphite powder and an additive are put thereinto, a first pressurizing unit connected to the first inlet and including a first pressurizing cylinder, a first high-pressure unit connected to the first pressurizing unit such that pressure applied by the first pressurizing cylinder is transmitted to the graphite powder in the first high-pressure unit, and a first extraction unit connected to the first high-pressure unit so as to extract primarily exfoliated graphite powder, a second graphite exfoliation apparatus including a second inlet configured such that the graphite powder extracted through the first extraction unit of the first graphite exfoliation apparatus is put thereinto, a second pressurizing unit connected to the second inlet and including a second pressurizing cylinder, a second high-pressure unit connected to the second pressurizing unit such that pressure applied by the second pressurizing cylinder is transmitted to the graphite powder in the second high-pressure unit, and a second extraction unit connected to the second high-pressure unit so as to extract secondarily exfoliated graphite powder, and a third graphite exfoliation apparatus including a third inlet configured such that the graphite powder extracted through the second extraction unit of the second graphite exfoliation apparatus is put thereinto, a third pressurizing unit connected to the third inlet and including a third pressurizing cylinder, a third high-pressure unit connected to the third pressurizing unit such that pressure applied by the third pressurizing cylinder is transmitted to the graphite powder in the third high-pressure unit, and a third extraction unit connected to the third high-pressure unit so as to extract thirdly exfoliated graphite powder.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Therefore, the scope of the present disclosure is defined not by the detailed description, but by the claims and their equivalents, and all variations within the scope of the claims and their equivalents are to be construed as being included in the present disclosure.

What is claimed is:

1. A graphite exfoliation system comprising:
a first graphite exfoliation apparatus comprising:
a first inlet configured such that water, graphite powder and an additive are put thereinto;
a first pressurizing unit connected to the first inlet and comprising a first pressurizing cylinder;
a first high-pressure unit connected to the first pressurizing unit such that pressure applied by the first pressurizing cylinder is transmitted to the graphite powder in the first high-pressure unit; and
a first extraction unit connected to the first high-pressure unit so as to extract primarily exfoliated graphite powder;
a second graphite exfoliation apparatus comprising:
a second inlet configured such that the graphite powder extracted through the first extraction unit of the first graphite exfoliation apparatus is put thereinto;
a second pressurizing unit connected to the second inlet and comprising a second pressurizing cylinder;
a second high-pressure unit connected to the second pressurizing unit such that pressure applied by the second pressurizing cylinder is transmitted to the graphite powder in the second high-pressure unit; and
a second extraction unit connected to the second high-pressure unit so as to extract secondarily exfoliated graphite powder; and
a third graphite exfoliation apparatus comprising:
a third inlet configured such that the graphite powder extracted through the second extraction unit of the second graphite exfoliation apparatus is put thereinto;
a third pressurizing unit connected to the third inlet and comprising a third pressurizing cylinder;
a third high-pressure unit connected to the third pressurizing unit such that pressure applied by the third pressurizing cylinder is transmitted to the graphite powder in the third high-pressure unit; and
a third extraction unit connected to the third high-pressure unit so as to extract thirdly exfoliated graphite powder.

2. The graphite exfoliation system according to claim 1, wherein:
each of inner cross-sectional areas of passages of the first high-pressure unit, the second high-pressure unit and the third high-pressure unit is constant;
the inner cross-sectional area of the passage of the first high-pressure unit is equal to or greater than the inner cross-sectional area of the passage of the second high-pressure unit; and
the inner cross-sectional area of the passage of the second high-pressure unit is equal to or greater than the inner cross-sectional area of the passage of the third high-pressure unit.

3. The graphite exfoliation system according to claim 2, wherein:
the first high-pressure unit, the second high-pressure unit and the third high-pressure unit are configured such that the inner cross-sectional areas of the passages thereof are within a range of 0.01 to 0.2 mm²; and
the graphite exfoliation system further comprises a controller configured to control pressure applied to the graphite powder in each of the first high-pressure unit, the second high-pressure unit and the third high-pressure unit to be within a range of 100 to 900 bar.

4. The graphite exfoliation system according to claim 3, wherein at least one of the first high-pressure unit, the second high-pressure unit or the third high-pressure unit comprises an adjuster configured to vary the inner cross-sectional area of the passage thereof.

5. A graphite exfoliation method comprising:
preparing a graphite exfoliation system comprising:
a first graphite exfoliation apparatus comprising:
a first inlet configured such that water, graphite powder and an additive are put thereinto;
a first pressurizing unit connected to the first inlet and comprising a first pressurizing cylinder;
a first high-pressure unit connected to the first pressurizing unit such that pressure applied by the first pressurizing cylinder is transmitted to the graphite powder in the first high-pressure unit; and
a first extraction unit connected to the first high-pressure unit so as to extract primarily exfoliated graphite powder;
a second graphite exfoliation apparatus comprising:
a second inlet configured such that the graphite powder extracted through the first extraction unit of the first graphite exfoliation apparatus is put thereinto;
a second pressurizing unit connected to the second inlet and comprising a second pressurizing cylinder;
a second high-pressure unit connected to the second pressurizing unit such that pressure applied by the second pressurizing cylinder is transmitted to the graphite powder in the second high-pressure unit; and
a second extraction unit connected to the second high-pressure unit so as to extract secondarily exfoliated graphite powder; and
a third graphite exfoliation apparatus comprising:
a third inlet configured such that the graphite powder extracted through the second extraction unit of the second graphite exfoliation apparatus is put thereinto;
a third pressurizing unit connected to the third inlet and comprising a third pressurizing cylinder;
a third high-pressure unit connected to the third pressurizing unit such that pressure applied by the third pressurizing cylinder is transmitted to the graphite powder in the third high-pressure unit; and
a third extraction unit connected to the third high-pressure unit so as to extract thirdly exfoliated graphite powder;
putting water, the graphite powder and the additive into the first inlet;
extracting the graphite powder passed through the first high-pressure unit through the first extraction unit by applying pressure to the graphite powder by the first pressurizing cylinder of the first pressurizing unit;
putting the graphite powder extracted through the first extraction unit into the second inlet;
extracting the graphite powder passed through the second high-pressure unit through the second extraction unit by applying pressure to the graphite powder by the second pressurizing cylinder of the second pressurizing unit;
putting the graphite powder extracted through the second extraction unit into the third inlet; and
extracting the graphite powder passed through the third high-pressure unit through the third extraction unit by applying pressure to the graphite powder by the third pressurizing cylinder of the third pressurizing unit.

6. The graphite exfoliation method according to claim 5, wherein:
each of inner cross-sectional areas of passages of the first high-pressure unit, the second high-pressure unit and the third high-pressure unit is constant;
the inner cross-sectional area of the passage of the first high-pressure unit is equal to or greater than the inner cross-sectional area of the passage of the second high-pressure unit;
the inner cross-sectional area of the passage of the second high-pressure unit is equal to or greater than the inner cross-sectional area of the passage of the third high-pressure unit;
the first high-pressure unit, the second high-pressure unit and the third high-pressure unit are configured such that the inner cross-sectional areas of the passages thereof are within a range of 0.01 to 0.2 mm²; and
the graphite exfoliation system further comprises a controller configured to control pressure applied to the graphite powder in each of the first high-pressure unit, the second high-pressure unit and the third high-pressure unit to be within a range of 100 to 900 bar.

7. The graphite exfoliation method according to claim 6, wherein:
a weight of the additive put into the first inlet is less than 5% of a weight of the graphite powder put together with the additive into the first inlet;
the additive is a carbon compound having a designated viscosity; and
the third high-pressure unit comprises an adjuster configured to vary the inner cross-sectional area of the passage thereof.
